(19) United States
(12) Patent Application Publication
(10) Pub. No.: US 2017/0042183 A1
(43) Pub. Date: Feb. 16, 2017

(54) COMPOSITE FROZEN CONFECTIONERY PROVIDING ENHANCED REFRESHMENT

(71) Applicant: NESTEC S.A., Vevey (CH)

(72) Inventors: Max Puaud, Pisseleu (FR); Sirichit Jiraruangkiat, Fourqueux (FR); Francois-Xavier Littoz-Baritel, Scionzier (FR); Steffen Dose, Bakersfield, CA (US)

(21) Appl. No.: 15/286,144

(22) Filed: Oct. 5, 2016

Related U.S. Application Data
(62) Division of application No. 13/128,374, filed on May 9, 2011.

(30) Foreign Application Priority Data
Nov. 10, 2008 (EP) 08168739.4

(51) Int. Cl. A23G 9/48; A23P 20/10; A23G 9/32

(52) U.S. Cl. CPC A23G 9/485; A23G 9/322; A23P 20/10; A23V 2002/00

(57) ABSTRACT

The present invention relates to a method for the manufacture of composite frozen confectioneries that provide an enhanced refreshing sensation upon consumption, the confectioneries comprising a soft core of aerated ice confection preferably comprising a refreshing block and a crispy ice coating.

### PRIORITY CLAIM

The present application is a divisional application of U.S. patent application Ser. No. 13/128,374, filed on May 9, 2011, which is a National Stage of International Application No. PCT/EP2009/063044, filed on Oct. 7, 2009, which claims priority to European Patent Application No. 08168739.4, filed Nov. 10, 2008, the entire contents of each of which are being incorporated herein by reference.

### FIELD OF THE INVENTION

The present invention relates to a refreshing composite frozen confectionery preferably a bite-sized product, formed by a soft core of aerated ice confection coated with a crispy aqueous-based ice layer. The core preferably comprises a refreshing block. The invention is further directed to a method for manufacturing the composite frozen confectionery.

### BACKGROUND

Composite frozen confectioneries comprising a core and a fat-based coating are widely described in the literature. In particular bite-sized products with a fat-based coating are known. These products cannot be qualified as “refreshing” as they leave a typical fatty feeling in the mouth after being consumed.

Composite frozen desserts made of an ice confection core and an aqueous-based coating are also known in the art. WO 0130175 describes for instance an aqueous-based coating for ice confections including sorbets. The coating there-described is based on a water-ice solution typically comprising sugars, stabilizers, fruit solids, citric acids, colors and water. Although fat-free, this type of coating contains a sugar level which usually leaves the consumer with a “thirst” sensation after consumption.

On the other hand, bite-sized water-ice products, also referred to as “ice balls”, are known to the consumer. Again these products contain sweetener agents and are not delivering intense refreshment. Furthermore, these products very small in size, have a hard texture in mouth. Their format and composition are not appropriate to deliver a refreshing experience.

Therefore, frozen confectioneries known up to date, although cold when distributed and consumed, have not been able to provide the consumer with a real refreshing experience, combined with a pleasant texture.

The present invention solves this problem and provides frozen confectioneries delivering a real freshness experience in the mouth together with a unique texture.

### SUMMARY

A first object of the invention is a composite frozen confectionery made of a soft core preferably improved by the presence of a refreshing block and surrounded by a crispy aqueous-based shell, which delivers real refreshment associated with a soft texture in mouth. What is meant by “real refreshment” is both mouth and mental refreshment with a sensation of “clean mouth” after consumption, avoiding any fatty or sweet aftertaste. A second object of the invention is a method for the preparation of such frozen confectionery.

The present invention relates, in a first aspect, to a composite frozen confectionery comprising

a) a soft aerated ice confection core preferably including a refreshing block, wherein the force used to penetrate a knife in the core at −10° C. does not exceed 100 Newton, preferably 50 Newton, and more preferably 20 Newton; and

b) a crispy aqueous-based ice shell, substantially free of sugars and fat.

Preferably, the composite frozen confection of the invention is bite-sized, with a volume comprised between 2 and 10 ml.

In a further aspect, the invention relates to a method for the manufacture of a composite frozen confectionery as defined above, comprising the steps of:

i) Providing an ingredient mix for ice confection preferably comprising a refreshing block;

ii) Freezing and aerating the mix;

iii) Dosing portions of the frozen mix to form frozen ice confections;

iv) Hardening the frozen ice confections;

v) Providing frozen ice confections with an aqueous-based coating, substantially free of fat and sugars to form composite frozen confectioneries;

vi) Hardening the composite frozen confectioneries.

### BRIEF DESCRIPTION OF THE DRAWINGS

FIG. 1 schematizes in a block diagram the method for the manufacture of a composite frozen confection according to the present invention.

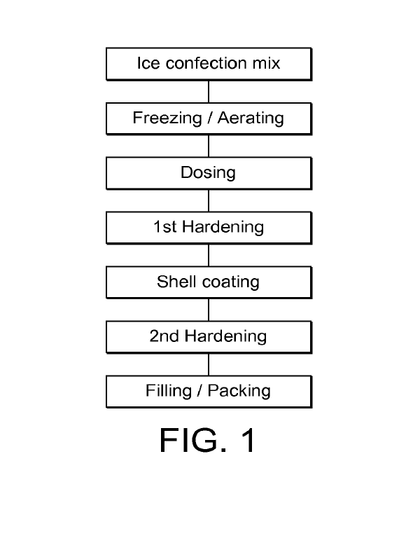

FIG. 2 shows the results of a penetrability test performed in bulk format on the aerated ice confection core of a composite frozen confectionery according to the invention (FIG. 2a), compared with an ice ball type product (FIG. 2b). The graphs represent the force (in Newton) used to penetrate a knife-like probe into the respective samples, namely the soft aerated confection core and the ice ball at −10° C. as a function of the distance of penetration in the product.

FIG. 3 is a view of two embodiments of composite frozen confections according to the invention.

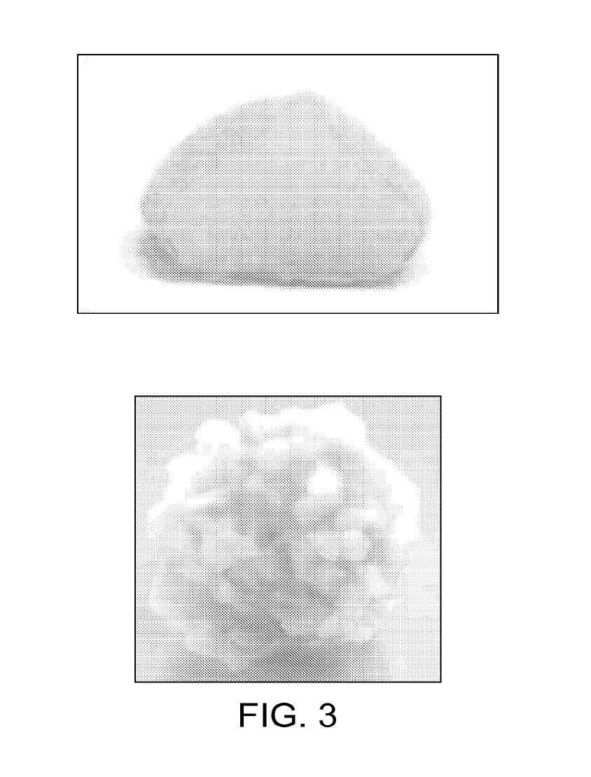

FIG. 4 represents a knife-like probe suitable for the penetrability test.

### DETAILED DESCRIPTION

The present invention is concerned with a composite frozen confectionery providing a new experience to the consumer in terms of improved refreshing sensation upon and after consumption, associated with a very pleasant texture in mouth.

Advantageously, it has been found that during the consumption of a frozen confectionery according to the invention, the consumer first experiences hydration and cleaning of the mouth through the quick melting of the crispy aqueous-based shell substantially free of fat and sugars, followed by a lasting refreshment experience provided by the melting of the soft core preferably including a refreshing block.

The composite frozen confection according to the invention advantageously overcomes fatty feelings usually perceived during, and lasting after consumption of ice cream bite-sized products. The sweet sensation is also limited, in order to avoid any thirst sensation after consumption. Above all, the specific combination of the aqueous-based shell and core leaves the consumer with a “clean mouth” effect.

In a preferred embodiment of the invention, the frozen confectionery is in the form of a bite-sized confection or “miniature”, with a volume typically comprised between 2 ml and 10 ml.

The composite frozen confectioneries can adopt various shapes, such as drops, spheres, cylinders, cubes, pyramids, sticks, triangles, diamonds/lozenges or cones.

The composite confectionery is made of a soft aerated ice confection core covered by an aqueous-based ice crispy shell.

Non limiting examples of “aerated ice confection core” within the meaning of the present invention include ice cream, sorbet, sherbet, water ice, frozen yoghurt, frozen dairy, soft ice, Mellorine, frozen custard, non-dairy frozen confection, milk ice, ice lolly, gelato and frozen jelly.

Preferably, the aerated ice confection core is a sorbet.

Aeration can be comprised between 10% and 200%, preferably between 10% and 50%.

The aerated ice confection core is characterized by its unique softness. The texture of the core in the frozen composite confectionery of the invention is soft and advantageously contrasts with the crispiness of the shell first experienced in the mouth. It has been found that the combination of the textures provided by the composite confectionery of the invention is particularly appreciated by the consumer. While the crispy shell quickly melts with the effect of hydrating and cleaning the mouth, the soft core remains longer in the mouth extending the refreshing sensation, without leaving any thirst impression.

The softness of the core can be measured by a penetrability test that measures a hardness index, i.e. the force to penetrate a defined sample with a metal knife-like probe.

Penetrability Test:

The test uses a texture analyser of the type TA-XT2i of SMS, equipped with a knife-like probe which measures at fixed temperature, the force in N needed to penetrate the probe within a sample, as a function of the distance covered within the sample.

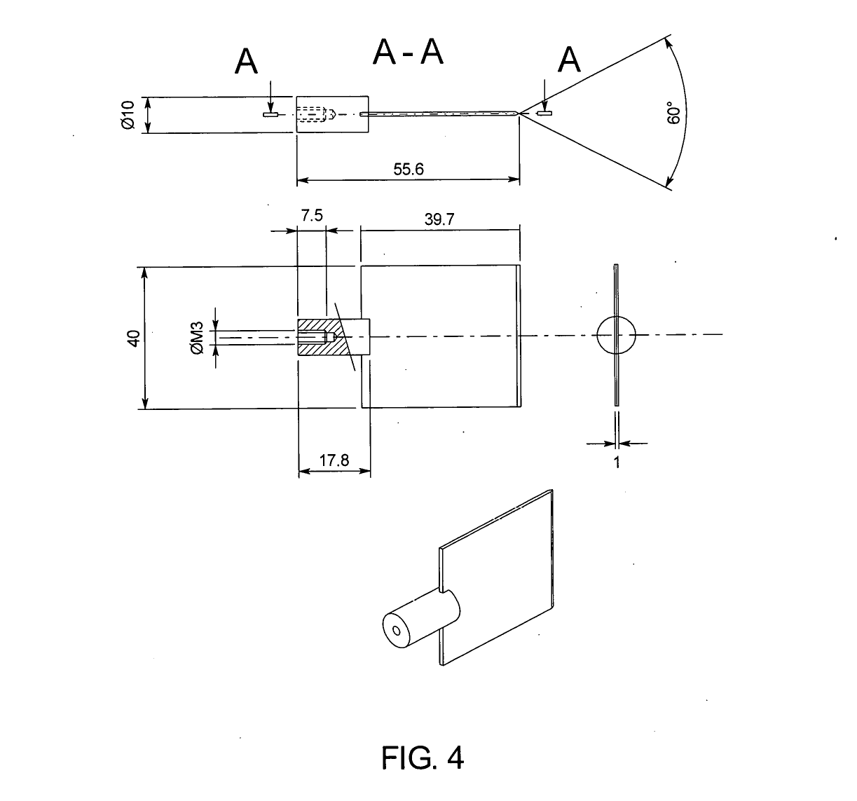

The knife like probe, made of stainless steel has the dimensions indicated in FIG. 4, namely a thickness of 1 mm, and a surface of 40×39, 7 mm. The 2 parts of the knife probe's forming the point which penetrates into a sample form an angle of 60°.

According to a penetrability test, the force used to penetrate a knife in the aerated ice confection core of the invention at −10° does not exceed 100 Newton, preferably 50 Newton and more preferably 20 Newton.

The aerated ice confection core composition is preferably characterized by the presence of a refreshing block.

By “refreshing block” is to be understood a composition that comprises at least one salivating agent and at least one cooling agent in a weight ratio of 1:0.05 to 1:0.2, preferably 1:0.11 and 1:0.16.

By “salivating agent” is to be understood any agent that induces salivation or a salivating reflex. It may also be described as a mouth watering, mouth wetting or mouth hydrating agent.

The salivating agent used in the present invention may be selected from a mixture of compounds comprising at least one organic acid selected from the group of adipic, ascorbic, citric, fumaric, lactic, malic and tartaric acids. These compounds stimulate salivary glands and thus enhance salivary flow. Such mixtures are commercially available, for example under the name of mouth watering flavoring.

By “cooling agent” is to be understood any agent that imparts a cooling sensation to the skin and mucous membranes of the body, particularly the mouth, nose, throat and gastrointestinal tract during consumption. Cooling agents are known in the art, for example from U.S. Pat. No. 7,090,832.

The cooling agent used in the present invention may be selected from menthol derivative compounds, acyclic and/or cyclic carboxamides, N-substituted paramenthane carboxamides, phosphine oxides, substituted p-menthanes, menthoxypropane, alpha-keto enamine derivatives, N-substituted p-menthane carboxamide, menthyl half acid ester derivatives, cubebol etc. Preferably, the cooling agent is a compound mixture comprising at least a menthol carboxamide compound.

According to another embodiment of the invention, the core of the composite frozen confectionery may further comprise a tingling agent.

By “tingling agent” is to be understood agents which trigger a trigeminal perception. These tingling agents may be selected from a plethora of compounds (plant extracts or synthetic compounds) that are known in the art to provide a tingling sensation and are used accordingly in a number of food products. Such plant extracts include extracts from pepper, onion, garlic, radish, horseradish, mustard, chili, ginger etc. These may more precisely include, but are not limited to Jambu Oleoresin or para cress (Spilanthes sp.) in which the active ingredient is Spilanthol; Japanese pepper extract (Zanthoxylum peperitum), including the ingredients known as Saanshool-I, Saanshool-II and Sanshoamide; black pepper extract (piper nigrum), including the active ingredients chavicine and piperine; Echinacea extract; Northern Prickly Ash extract; and red pepper oleoresin.

Preferably, the core of the composite frozen confectionery comprises the salivating agent in an amount of 0.1-0.5 wt %, preferably 0.25-0.4 wt %, more preferably 0.28-0.35 wt %. The cooling agent is present in the frozen dessert of the invention in an amount of 0.01-0.1 wt %, preferably 0.02-0.05 wt %, more preferably 0.02-0.045 wt %, even more preferably 0.03-0.045 wt %, most preferably 0.032-0.045 wt %.

The ice confection core in the invention may further comprise a mixture of malic acid and citric acid. This helps providing an organoleptic balance between sweetness and acidity in the final product.

If a tingling agent is used, it is preferably used in an amount of 0.01-0.05 wt % of the ice cream or sorbet core.

It has also been found that the presence of a mucoadhesive agent in the composition of the core of the composite frozen confectionery is advantageous in the present invention. Indeed, mucoadhesive polymers such as hydroxypropylmethylcellulose (HPMC) and carboxymethylcellulose (CMC) have been shown to further enhance the salivating sensation after consumption.

Preferably, the mucoadhesive agent used in the present invention is CMC. When it is used in the aerated ice confection core of the invention, it is preferably added at an amount of about 0.05-0.5%, preferably 0.1-0.3%, most preferably about 0.1%.

In one embodiment, the core of the composite frozen confectionery consists in a sorbet. By sorbet it is meant an aerated frozen dessert with fruit addition. Preferably, the sorbet core includes a refreshing block in amounts comprised between 0.2 and 0.5 wt % of the composition.

Preferably, the aerated sorbet core further includes sugars or sweetening agents in a range comprised between 16% and 20% by weight; fruit and fruit juice in a range comprised between 1.5 and 4% by weight of the core composition, stabilizers in a range comprised between 0.22 and 0.32% by weight.

The sorbet core has an overrun typically comprised between 10% and 50%. The sorbet core may further comprise acidic fruity ingredients, flavors and colors. These may be pieces of acidic fruits such as citrus fruits, peach, grapefruit, etc. or the juice of the fruits or pulp, or combinations thereof. These ingredients further enhance the refreshing sensation by providing specific fruity olfactory notes.

In another embodiment, the core of the composite frozen confectionery consists in an ice cream. In addition to the refreshing block, the latter comprises typical ingredients known from a skilled person in the art and described in reference books such as Ice Cream, 5^{th} Edition, by Robert T. Marshall and W. S. Arbuckle, including fat, milk solids non fat, sweetening agents, stabilizers and emulsifiers. Typical ranges for the mentioned ingredients are:

Fat: 1-10% by weight in the aerated ice confection core

MSNF: 2-10% by weight in the aerated ice confection core

Sweetening: 12-16% by weight in the aerated ice confection core

Stabilizer: 0.2-0.8% by weight in the aerated ice confection core

Emulsifier: 0.01-0.1% by weight in the aerated ice confection core

In the composite frozen confectionery of the invention, the soft core of aerated ice confection is surrounded by an aqueous-based crispy shell covering at least partially and preferably entirely the core. The shell is substantially free of sugars and fat.

Sugars, as defined in “Diet, nutrition and the prevention of chronic diseases”—Report of a Joint WHO/FAO Expert Consultation, WHO Technical Report Series 916, WHO, Geneva, 2003 include all mono and disaccharides added by the manufacturer, cook, or consumer i.e. “free sugars”, plus sugar naturally present and sourced from honey, syrups and juices.

The water shell has a harder texture than the core and therefore provides the consumer with a cracking perception in mouth which adds a texture contrast to the product.

Its composition substantially free of sugar and fat contributes to the overall refreshing sensation provided by the composite frozen confectionery of the invention and also contributes to the “clean mouth” effect perceived and the absence of thirst sensation after consumption.

The shell is mainly based on water. In a particular embodiment, the shell essentially consists in water.

In another embodiment, the shell comprises in addition to water, at least one ingredient selected from flavoring and coloring agents, stabilizers, and an agent susceptible of preventing micro-organic growth.

Examples of agents susceptible of preventing micro-organic growth include acids such as citric, tartaric, malic, ascorbic, erythorbic and lactic acids; and preservatives.

Examples of stabilizers include guar gum, xanthan gum, carrageenan, locust bean gum, sodium alginate, and CMC.

Preferably, the shell is a thin layer with a thickness comprised between 300 μm and 600 μm. This characteristic advantageously provides reasonable heat shock stability to the product.

In a specific embodiment, further to the shell surrounding the ice confection core, the composite product comprises an additional continuous or discontinous layer made of ice crystals covering the shell. Preferably, the ice crystal size of this additional layer is bigger than 1 mm.

Having ice crystals as additional layer is boosting up contrast texture sensation, and enhances refreshing and clean mouth effect.

The present invention is further directed to a method for the manufacture of a composite frozen confectionery as defined above, comprising the steps of:

i) Providing an ingredient mix for ice confection preferably comprising a refreshing block;

ii) Freezing and aerating the mix;

iii) Dosing portions of the mix with a defined shape;

iv) Hardening the frozen ice confection;

v) Applying an aqueous-based coating substantially free of sugar and fat, covering partially or totally the ice confection to provide a crispy shell surrounding the ice confection;

vi) Hardening the obtained composite frozen confectionery.

The ingredient mix is based on standard ingredients used for the preparation of an ice confection and well known from a skilled person in the art. Additionally, it preferably comprises a refreshing block as defined above. The ingredient mix provided at a temperature typically below 4° C. is cooled and aerated in a standard freezer at temperatures typically comprised between −3 and −4° C. Overrun can be comprised between 10 and 200%, preferably between 10 and 50%. It is necessary to ensure that proper level of overrun with homogeneous aeration is obtained and maintained consistently to ensure the softness of ice confection core.

The frozen mix is further dosed in portions with a defined shape. Any dosing equipment can be used to perform this step such as, for instance an extruder or molding equipment.

In a particular embodiment wherein the method is directed to the preparation of bite-sized products, i.e. individual portions in specific pattern, a dosing apparatus which enables dosing a pattern of ice confection to a continuously transported tray can advantageously be used. Such equipment is for instance described in EP 0741972, the content of which is here included by reference.

Further to the hardening of the aerated frozen confection core, the latter is coated with the aqueous-based composition. Methods to coat the soft core include enrobing, dipping, spraying, water fall or curtain, showering or bottoming.

Preferably the shell is applied by spraying, bottoming or water fall.

In a particular embodiment, the aqueous-based coating is followed by addition of ice crystals covering at least partially the surface of the composite product.

The coated product goes then through a second hardening step.

The invention will now be further described by way of the following examples which should not be considered as limiting the invention.

### EXAMPLES

### Example 1

A composite frozen confection was prepared based on the following composition:

1) sorbet core composition

| Ingredient % | |
|---|---|
| | by weight |
| Stabilizers | 0.27 |
| Sucrose | 18.00 |
| Citric acid | 0.40 |
| Lemon juice concentrate | 2.00 |
| Refreshing block* | 0.35 |
| Flavor | 0.03 |
| Color | 0.0008 |
| Water | made to 100 |
| | % by weight in sorbet |
| | core composition |
| Mouth watering agent | 0.25 |
| Cooling agent | 0.05 |
| Tingling agent | 0.05 |

*composition of the refreshing block:

The mix of ingredients was stored homogenized, pasteurized at standard conditions before being stored at a temperature below 4° C. The mix was then cooled and aerated in a freezer with temperature comprised between −3 and −4° C., under a pressure comprised between 3 and 5 bars and a flow rate comprised between 150 and 160 L/h. An overrun of 20% was provided.

The sorbet core composition was then dosed in individual portions by passage through an extruder equipped with a dosing head onto a conveyor belt. An equipment similar to that described in EP0141972 was used.

After a passage through hardening tunnel each individual frozen core was coated with pasteurised water at a temperature below 4° C.

A second passage in a hardening tunnel finalized the process.

### Example 2

A comparative penetrability test between the core of a composite frozen confectionery according to the invention on the one hand and an “ice ball” type of product on the other hand has been performed.

A sorbet core composition as described in Example 1 was used as sample a).

An ice ball product comprising water, sugars, lime juice, citric acid, sodium cyclamate, flavoring, and coloring was used as sample b).

Ice Ball Composition:

| Ingredient | % by weight |
|---|---|
| Liquid sugar 65% | 15.00 |
| Sodium cyclamate | 0.06 |
| Citric acid | 0.65 |
| Flavor Lime | 0.25 |
| Color | 0.04 |
| Lime juice | 2.50 |
| Water | 81.50 |

Ice ball manufacturing process:

i) Providing an ingredient mix for ice ball;

ii) Reaching freezer drum to produce ice flakes;

iii) Feeding ice flakes to ball former;

iv) Filling ice balls into the container;

v) Hardening the ice balls.

Hardness measurement via penetration test and process parameters:

The hardness index is defined as the force to penetrate the sample with a metal knife-like probe in a penetrability test.

The method is based on the resistance of both products to the penetration of a knife-like probe, using a texture analyzer TA-XT2i of SMS.

In this example, each product was tested at a temperature of −10°±1° C.

Equipment:

Horizontal deep freezer was used for sample preparation with uniform and programmable temperature.

Sample Preparation:

In order to compare the hardness of both recipes, both products were prepared in bulk to eliminate the effects from different formats.

The samples surface was ensured to be plane. The samples were then placed inside the freezer conditioned at the temperature of analysis) (−10° C.±1°).

The analyses were performed 16 hours later. Measurements were performed at room temperature. The hardness index or force was plotted against the distance within the sample.

Results

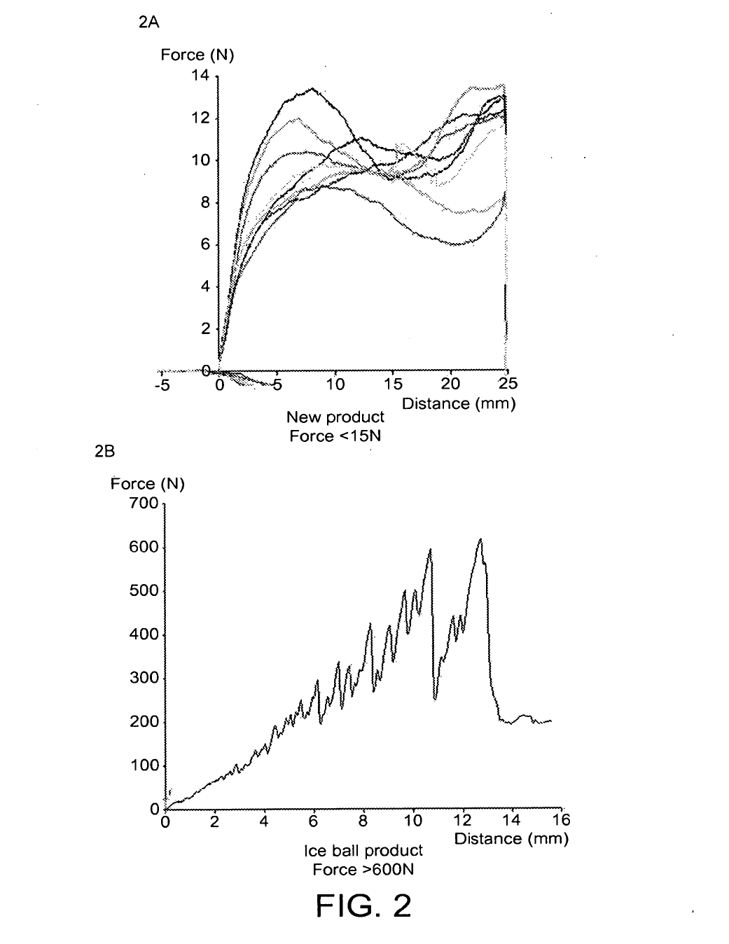

Results are shown on FIGS. 2a) and 2b).

Height measurements were done on sample a) and are reported on Figure a). The force used to penetrate the knife-like probe into the sample, at a maximum depth of 25 mm, did not exceed 15 N.

Only one measurement was done on sample b) due to the hard texture of the sample which prevented the knife-like probe to enter the sample, even when penetration force was increased to more than 600 N.

### Example 3

The refreshing sensation provided by the composite frozen confections according to the invention was compared with the refreshment provided by an “ice ball” type of product on 156 consumers.

Consumers tested a composite frozen confection as described in Example 1 and an ice ball confection as described in Example 2. The following questions were independently asked for each product:

1) what is your overall opinion on the refreshing taste of the product? Rate on a scale from 1 (extremely not refreshing) to 7 (Extremely refreshing).

2) To what extend do you agree or disagree that this product thirst quenching? Rate on a scale from 1 (disagree strongly) to 5 (agree strongly).

3) What is your overall opinion of the texture of this product? Rate on a scale from 1 (extremely poor) to 7 (Excellent).

Results are reported in Table 1.

TABLE 1

| | | Composite | |
|---|---|---|---|
| | | frozen | |
| | | confection | Ice ball |
| Refreshing | Top 1 Base (Extremely refreshing) | 52.6% | 41.7% |
| taste | Top 2 Base | 91.0% | 90.4% |
| | (Extremely/very refreshing) | | |
| Quenching | Top 1 Base (Agree strongly) | 30.1% | 27.6% |
| | Top 2 Base | 69.2% | 65.4% |
| | (Agree strongly/slightly) | | |
| Overall texture | Top 1 Base (Excellent) | 10.9% | 7.7% |
| | Top 2 Base | 43.6% | 32.1% |
| | (Excellent & Very Good) | | |
| Smoothness | Top 1 Base (Agree strongly) | 33.3% | 26.3% |
| | Top 2 Base | 74.4% | 64.1% |
| | (Agree strongly/slightly) | | |

“Top 1 Base” reflects the percentage of consumers rating for a product independently from the other, the top 1 answer (e.g. extremely refreshing)

Top 2 Base reflects the percentage of consumers rating for a product independently from the other, either top 1 or top 2 answer (e.g. extremely refreshing or very refreshing).

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method for the manufacture of the composite frozen confectionery, the method comprising the steps of:
providing an ingredient mix for an ice confection block, the mix comprising at least one salivating agent and at least one cooling agent in a weight ratio of 1:0.11 to 1:0.2 respectively;
freezing the mix and providing a degree of overrun of between 20 and 200%;
dosing portions of the frozen confection with a defined shape onto a continuously transported tray;
hardening the frozen ice confection;
applying an aqueous-based coating covering the ice confection to provide a composite confectionery; and
hardening the composite confectionery.

2. The method according to claim 1, wherein the dosing step is performed using an extruder equipped with a dosing device.

3. The method according to claim 1, wherein the aqueous-based coating is applied by a step selected from the group consisting of enrobing, dipping, showering, water fall and spraying.

4. The method according to claim 1, wherein the aqueous-based coating is applied by bottoming or water fall.

5. The method according to claim 1, wherein the hardening of the frozen ice confection step is followed by providing the composite frozen confection with an additional layer of ice crystals.

6. The method according to claim 1, wherein the aqueous-based coating has a thickness of between 300 and 600 μm

7. The method according to claim 1, wherein the composite frozen confectionery is in a form of a bite-size product with a volume of between 2 and 10 ml.

8. The method according to claim 1, wherein the ice confection is a sorbet.

9. The method according to claim 1, wherein the defined shape is selected from the group consisting of a drop, sphere, cylinder, cube, pyramid, stick, triangle, diamond, losange, and cone.

10. The method according to claim 1, wherein the salivating agent is at least one organic acid selected from the group consisting of adipic, ascorbic, citric, fumaric, lactic, malic and tartaric acids.

11. The method according to claim 1, wherein the cooling agent is selected from the group consisting of menthol derivative compounds, acyclic and/or cyclic carboxamides, N-substituted paramenthane carboxamides, phosphine oxides, substituted p-menthanes, menthoxypropane, alpha-keto enamine derivatives, N-substituted p-menthane carboxamide, menthyl half acid ester derivatives and cubebol.

12. The method according to claim 1, wherein the mix comprises a tingling agent.

13. The method according to claim 12, wherein the tingling agent is selected from plant extracts.

14. The method according to claim 13, wherein the plant extracts are selected from the group consisting of pepper, onion, garlic, radish, horseradish, mustard, chili and ginger.

15. The method according to claim 12, wherein the tingling agent is Szechuan pepper extract.

16. The method according to claim 1, wherein the salivating agent is present in an amount of 0.1-0.5 wt %, with respect to the weight of the ice confection core.

17. The method according to claim 1, wherein the cooling agent is present in an amount of 0.01-0.1 wt %, with respect to the weight of the ice confection core.

18. The method according to claim 1, wherein the mix comprises malic acid and citric acid.

19. The method according to claim 1, wherein the aqueous-based coating consists of an ice water layer.

20. The method according to claim 1, wherein the aqueous-based coating comprises water and at least one ingredient selected from the group consisting of flavors, colors, acids and stabilizers.
